(19) United States
(12) Patent Application Publication
(10) Pub. No.: US 2005/0277434 A1
(43) Pub. Date: Dec. 15, 2005

(54) Access controller

(75) Inventors: Jukka Tuomi, Tampere (FI); Sami Pienimaki, Pirkkala (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/965,193

(22) Filed: Oct. 15, 2004

(30) Foreign Application Priority Data
Jun. 11, 2004 (GB) 0413080.3

(51) Int. Cl. H04Q 7/20

(52) U.S. Cl. 455/509

(57) ABSTRACT

An access controller for use in a communication network comprising: a first address space for use by a user equipment in communication with the access controller via a first port; a second address space for use via an external network in communication with the access controller via a second port; a processor configured to read incoming requests at the first and second ports wherein requests of a predetermined type issued by the user equipment to be implemented at the access controller are received at the first port yet addressed to the second address space.

### FIELD OF THE INVENTION

The present invention relates to an access controller and in particular but not exclusively to an access controller for use as part of a virtual private network.

### BACKGROUND OF THE INVENTION

A typical public wireless local area network has at its core an access controller. The access controller is capable of communicating wirelessly with user equipment (such as personal computers, personal digital assistants and other mobile communication devices). The access controller further acts as a gateway from the service provider's public wireless local area network (WLAN) to other networks. These networks can be used by the connecting user equipment to communicate with other devices. The access controller can also connect to the other networks, to allow access charging, or to get authentication or authorisation information confirming the identity of the connecting user equipment. Access controllers can also be used in other network access environments, such as providing user equipment access to other networks via digital subscriber lines (xDSL).

Access controllers (such as those creating public WLAN access zones) typically incorporate a browser based universal access method (UAM). The UAM allows a user to access the system using a simple Internet browser, such as Internet Explorer, or Netscape Navigator. The access controller has a private address space accessible only by the user equipment in authorised communication with it over a private port, and a public address space accessible by any other entity (not necessarily authorised) over a public port. The user equipment browser requests a uniform resource location (URL) located in the private address space of the access controller. The address space typically contains information allowing the user equipment to authorise itself, to display status information and to provide a WLAN disconnect or logoff function.

A major security concern is the interception of data transmitted from the user equipment to the destination device and vice versa.

One approach to overcome these security concerns known in the art is the use of a virtual private network tunnelling protocol between the user equipment and a virtual private network gateway. In such an arrangement the user equipment connected to the access controller at the private port, establishes a through link to a virtual private network (VPN) gateway via any other network connected to the public port. The VPN protocol encrypts the data sent to and from the user terminal equipment to the VPN gateway.

The universal access method (UAM) interfaces fail when a user uses a VPN protocol between the user equipment and VPN gateway, as the access controller is incapable of detecting a disconnection request following the VPN initiation. This failure is partially because of the encryption of the request packets which render the packets invisible to the access controller because it does not have the key to decrypt them, and also partially because once the packet has reached the VPN the private address space addressed by the decrypted packet is not visible to the VPN because it exists at the access controller private port, whereas the VPN can only see the public port.

This failure in the disconnection request prevents the access controller operator correctly calculating the connection time and maintaining too many ‘open’ connections. Furthermore in the example of the status update the information provided to the user can be incorrect.

One solution to this problem has been the use of session timers within the access controller. A session timer automatically carries out a request after a fixed time period. Thus user equipment connected to the access controller are supplied updated information and also regularly disconnected.

This solution though only prevents the operator maintaining too many connections and does not address the connection time problem. The session timer method also requires the user to re-authenticate and identify itself in order to re-establish a connection to the access controller on a regular basis.

It is the aim of the embodiments of the present invention to provide address or at least mitigate the problems described above.

### SUMMARY OF THE INVENTION

There is provided according to the invention an access controller for use in a communication network comprising: a first address space for use by a user equipment in communication with the access controller via a first port; a second address space for use via an external network in communication with the access controller via a second port; a processor configured to read incoming requests at the first and second ports wherein requests of a predetermined type issued by the user equipment to be implemented at the access controller are received at the first port yet addressed to the second address space.

The request of a predetermined type may be a request to open a uniform resource location (URL) in the second address space.

The request of a predetermined type may be one of a status update and a disconnect request.

The request of a predetermined type may be encrypted, and wherein the processor is preferably configured to transmit the request received at the first port to the external network via the second port, where it is preferably decrypted, and to subsequently receive the decrypted request at the second port.

The processor may be configured to recognize that an incoming request at the first port is addressed to the second address space and to preferably implement the request at the access controller.

The request may comprise information identifying said user equipment.

The information identifying said user equipment may comprise a session id.

The processor may be configured to send a response to the user equipment after implementing the request at the access controller.

The processor is preferably arranged to disconnect said user equipment when said request is a disconnect request.

The response may comprise status information.

The external network may comprise a virtual private network (VPN) gateway.

The first port is preferably a private communications port.

The second port is preferably a public communications port.

The first address space is preferably a private address space.

The second address space is preferably a public address space.

The user equipment is preferably in wireless communication with the access controller via the first port.

According to a second aspect of the present invention there is provided a communications system comprising: at least one user equipment; at least one external network; and an access controller wherein said access controller comprises: a first address space for use by said user equipment in communication with the access controller via a first port; a second address space for use via said external network in communication with the access controller via a second port; a processor configured to read incoming requests at the first and second ports wherein requests of a predetermined type issued by the user equipment to be implemented at the access controller are received at the first port yet addressed to the second address space.

According to a third aspect of the invention there is provided a method of controlling access in a communications network including an access controller, a user equipment in communication with the access controller via a first port associated with a first address space and an external network in communication with the access controller by a second port associated with a second address space, comprising the steps of: transmitting from the user equipment a request to be implemented at the access controller and identifying a location in the second address space; and implementing the request at the access controller.

The request is preferably one of a status update and a disconnect request.

The method may comprise the step of issuing a response to the user equipment after implementing the request at the access controller.

The request transmitted from the user equipment is preferably encrypted, said method may further comprise the steps of: transmitting said request to said external network; decrypting said request at said external network; and returning said decrypted request to the access controller.

The request is preferably read at said access controller on its arrival at the first port.

The location is preferably a uniform resource location (URL).

The request is preferably transmitted from the user equipment to the access controller over a wireless link.

According to a fourth aspect of the invention there is provided a user equipment comprising: a first port arranged to establish a communications link to an external network via an access controller; a processor arranged to count encrypted data packets transmitted over the communications link and to generate a status report for the communications link using the result of the count, said status report being independent of the decryption of the encrypted data packets.

The processor is preferably arranged to execute a program for updating a status window at the user equipment.

The program may be a javascript program.

According to a fifth aspect of the invention there is provided a method of reporting status in a communications network comprising an access controller, and a user equipment in communication with the access controller via a communications link, comprising the steps of: counting encrypted data packets transmitted over the communications link; and generating a status report for the communications link using the result of the counting step, said status report being independent of the decryption of the encrypted data packets.

The method may further comprise the step of updating a status window at a user equipment using said status report.

The step of updating a status window may comprise the step of running a javascript program.

### BRIEF DESCRIPTION OF THE DRAWINGS

For a better understanding of the present invention and how the same may be carried into effect, reference will now be made by way of example only to the accompanying drawings in which:

FIG. 1 shows a schematic view of a typical communications network incorporating an embodiment of the present invention within an access controller;

FIG. 2 shows a flow diagram showing the method used in performing an update as applied to an access controller in an embodiment of the present invention;

FIG. 3 shows a flow diagram showing the method used in performing a status update according to a second aspect of the present invention.

### DETAILED DESCRIPTION OF EMBODIMENTS OF THE PRESENT INVENTION

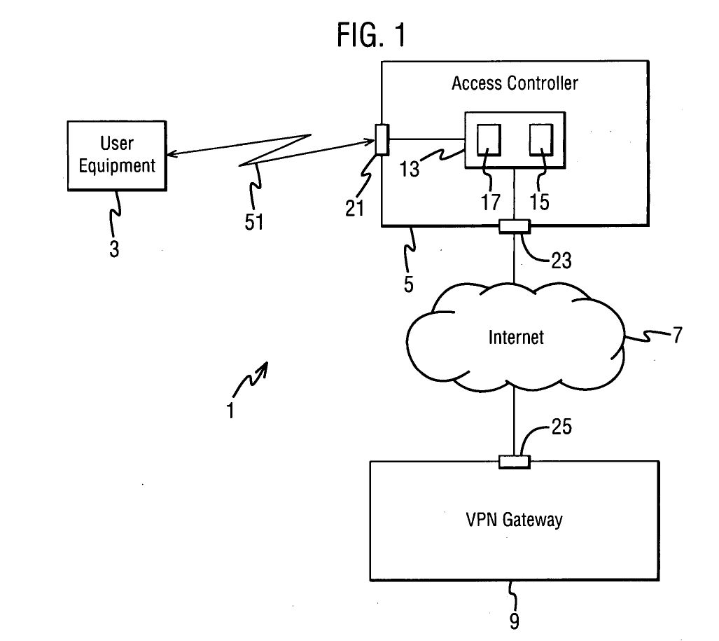

Reference is made to FIG. 1, which shows a first embodiment of the invention incorporated into an access controller in a typical network environment.

The network environment 1 comprises user equipment 3, access controller 5, Internet 7, and VPN gateway 9.

The user equipment 3 can be a personal computer equipped with wireless local area network (WLAN) capability such as described in the wireless local area network standard such as IEEE 802.11, and/or IEEE 802.1X. The IEEE standards 802.11 and 802.1X are available from the IEEE www site http://standards.ieee.org/getieee802/ which are hereby incorporated by reference. User equipment may also be personal digital assistants (PDA), mobile telephones, or other mobile communication devices.

The user equipment 3 is capable of connecting over the wireless local area network connection to the access controller 5. The access controller comprises a controller 13, a private communications port 21, and a public communications port 23.

The controller 13 comprises a private address space 17, and a public address space 15. The access controller 5 is described in further detail later. FIG. 1 shows the access controller connected to the virtual private network gateway 9 via the Internet 7.

The Internet 7 comprises a network of computers communicating using a series of standard protocols. The Internet is shown to have at least one connection further connected to a virtual private network (VPN) gateway 9 via a VPN gateway 25.

The virtual private network (VPN) gateway 9 is a communication node capable of receiving data packets via an unsecured network from a user, decrypting and authenticating these packets before forwarding the packets to either secure destinations within the secure network (not shown) or back via the un-secure network.

A virtual private network as known in the art is a private data network that makes use of a public telecommunication infrastructure, maintaining privacy through use of tunnelling protocols and security procedures. Such protocols are known in the art and are described in many request for comments (RFC) documents published by the Internet Engineering Task Force IETF including RFC 2401, RFC 2406, RFC 2407, RFC 2408, and RFC 2409 hereby incorporated by reference.

As previously mentioned the access controller 5 comprises a controller 13 containing a private address space 17 and a public address space 15. These address spaces are able to be accessed using uniform resource location (URL) address standards.

The private address space is addressable from user equipment 3 connecting to the access controller 5 via the private communications port 21. In the example shown in FIG. 1 where the access controller is a WLAN access controller the connection medium is that of the wireless local area network connection 51. The user equipment in connecting to the private address space 17 can transmit or receive information from the access controller using programs such as common gateway interface (CGI) scripts.

These scripts can be used, for example, to pass authorisation and authentication information to the access controller 5, or to gather status information from the access controller 5 and pass it to the user equipment 3. An example of a process requiring the access of the private address space is the user equipment connection or ‘logon’ process. The user equipment 3 addresses a known URL address within the access controller 5. The URL and scripts associated with the URL then allow the user equipment to enter information enabling the user equipment access to the other networks. The information may further be used to authenticate the user and allow access billing to be made. Furthermore the access controller 5 can pass a specific session id to the user equipment 3, the session id capable of being used as an authenticating token at a later time.

The public address space 15 is also accessed using uniform resource location (URL) address standards. The public address space 15 is typically used by equipment connecting to the access controller 5 via the public communications port 23.

The public address space 15 in embodiments of the present invention further comprise URL address locations enabling user equipment connected via the private communications port 21 to request a process such as log-off or status update. The URLs are associated with common gateway interface scripts aiding process.

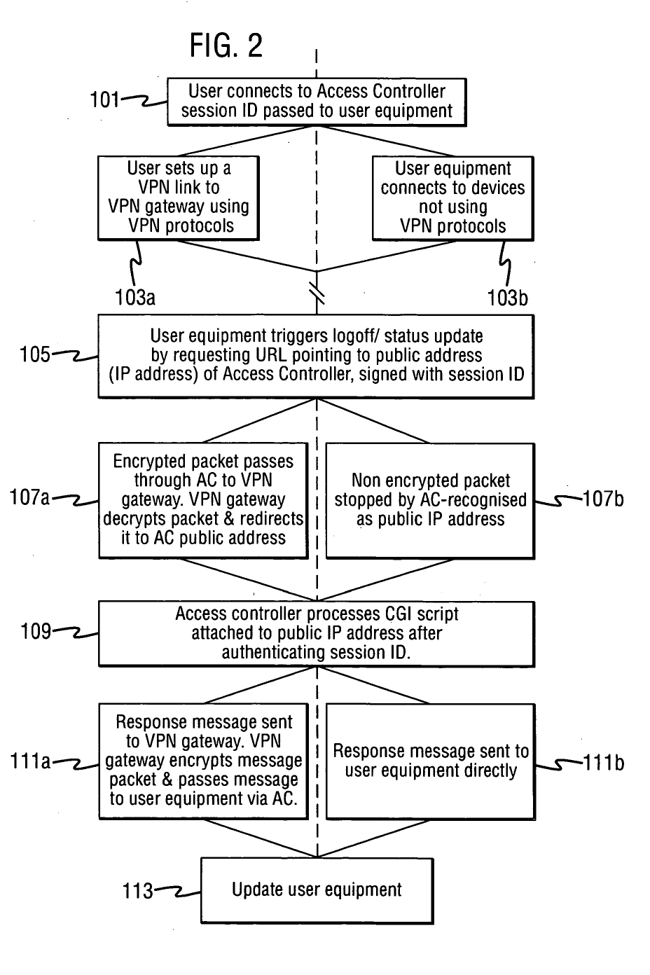

The use of a public address space in receiving user equipment 3 requests such as ‘logoff’ and status update requests can be described with reference to FIG. 2. The figure shows an initial connection or ‘logon’ of user equipment 3 to an access controller and a subsequent request from the user equipment 3 to the access controller 5. The requests described are a disconnect or ‘logoff’ request and a status update request. It will be clear that the present invention extends to capabilities of the public address space 15 in handling other requests. FIG. 2 shows the embodiments of the present invention where the user equipment connects to a VPN gateway 9, shown by the left branches of FIG. 2, and does not connect to a VPN gateway, shown by the right branches of FIG. 2.

During a first step 101, the user equipment contacts the access controller 5 via the wireless network link 51. Using a UAM the user equipment can carry out the connection or ‘logon’ procedure by opening a URL in the private address space 17 of the access controller 5. The access controller 5 authenticates and authorises the user equipment 3 to access other networks via the public communications port 23. The access controller 5 passes a response message to the user equipment 3, the response message including a session id code.

Step 103a shows the step where the user sets up a virtual private network (VPN) link to a VPN gateway 9 using VPN protocols. Once the VPN gateway 9 has authorised the user equipment, data between the user equipment and VPN gateway 9 is encrypted using the known tunnelling protocols.

Step 103b shows the alternative to step 103a. In this step the user equipment connects to devices not using VPN protocols.

Step 105 shows when the user equipment 3 wishes to trigger a request such as a ‘logoff’ or status update. This trigger may be initiated by the user manually, such as by pressing a request button on an Internet browser interface, or by the user equipment automatically, for example by the expiry of an update timer.

The user equipment 3 requests a URL located in the public address space 15 of the access controller 5. The user equipment 3 also transmits the session id as a variable passed as part of the URL string.

Step 107a describes the process when the request packet sent from the user equipment 3 has been encrypted using VPN tunnelling protocols. In this step the encrypted packet passes through the access controller 5 and the Internet 7 to the VPN gateway 9. At the VPN gateway 9 the packet is decrypted and the final address for the packet determined. As the address contained within the URL points to the public address space 15 of the access controller 5 the VPN gateway redirects the packet back through the Internet 7 to the access controller 5. The access controller 5 receives the packet via the public communications port 23.

Step 107b shows the alternative situation when the user equipment is not using VPN tunnelling protocols. In this step the controller 13 of the access controller 5 is able to determine that the address of the request packet is that of the public address space 15 of the access controller 5. The controller 13 internally routes the request packet to the public address space 15.

Step 109 describes the process after the access controller public address space 15 has received the URL request packet. The access controller 5 performs an authentication on the session id provided in the URL string to determine that the session id is a valid user equipment id. Having authenticated the user terminal the access controller 5 performs the CGI script attached to the requested location in the public address space 15. The use of the session id prevents any third party disconnecting the user equipment without having the required authorisation to do so.

Where the requested URL is that connected to a status update request, the access controller gathers any information required, formats the information, and addresses an information response message to the user equipment using the session id as a pointer to the user equipment address.

Where the user equipment has requested a disconnect or ‘logoff’, the access controller initiates the ‘logoff’ procedure, and prepares a ‘logoff’ OK response message to be addressed to the user equipment.

In step 111a the response message is sent to the VPN gateway over the Internet 7. The VPN gateway 9 encrypts the message packet according to VPN tunnelling protocols and passes the message to the user equipment via the Internet 7, and the access controller 5.

Step 111b shows the alternative to step 111a where the user equipment 3 is not using a VPN tunnelling protocol. In this step the reply message is sent directly to the user equipment 3 over the WLAN communications link 51.

In the final step 113, the user equipment 3 receives the response message. In the case of response messages received using the VPN tunnelling protocol the message is initially decrypted. The user equipment 3 uses the response message to provide an update to the user such as a ‘logoff OK’ message or a status update on the status page.

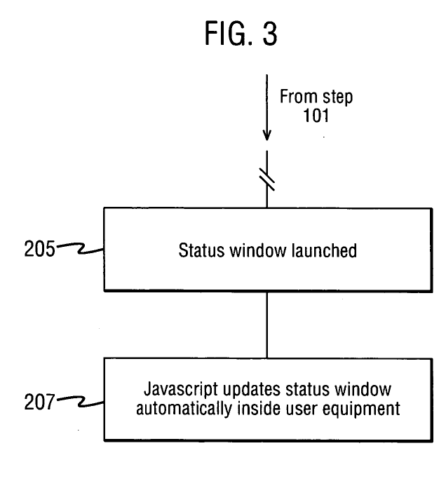

With respect to FIG. 3 an alternative embodiment of the present invention is shown for providing status update information whether or not the user equipment has formed a VPN connection to a VPN gateway 9. FIG. 3 shows the steps following step 101 in FIG. 2.

In step 205 a status window is launched in the user equipment 3. The user equipment 3 thus displays the status at the point of establishing a connection with the access controller 5.

In the next step 207 the user equipment 3 furthermore launches a program operable on the user equipment 3, such as that of a Javascript program, which monitors the data being passed to the user equipment 3. The monitoring by the Javascript program enables the user equipment to monitor the current status of the link between the user equipment 3 and the access controller 5 without requiring the user equipment 3 to request a status update from the access controller 5.

In both embodiments described above the user equipment is therefore capable of updating information and carrying out functions independent of VPN links.

In other embodiments of the present invention the passing of the session id with the URL request is optional, with authentication of the user terminal implemented using shared information between the VPN gateway 9 and the access controller 5.

Furthermore in other embodiments of the present invention the network of computers between the access controller 5 and the VPN gateway may be any unsecured or partially secured network of computers, such as an Intranet of computers. In other embodiments of the present invention the access controller 5 is connected directly to the VPN gateway 9.

Alternative embodiments of the present invention provide that the access controller 9 comprises a single address space accessible from both the private communications port 21 and public communications port 23. In other embodiments of the present invention the address space addressable from the public communications port 23 is only responsive to request packets transmitted from VPN gateways known to the access controller.

In further embodiments of the invention the access controller is connected to the user equipment via a wireless access point (not shown). The wireless access point extends the coverage of the access controller 5 and may be connected to the access controller by a wireless or fixed communications link.

In other embodiments of the invention the security of the access controller can be further improved by the addition of a firewall, as known in the art, between the access controller and the unsecured network, e.g. the Internet. The firewall would aid security of the system for example in preventing hypertext transfer protocol (http) spoofing attacks and also preventing denial of services (DoS) attacks.

The above embodiments have been described with respect to their application within an access controller in a wireless local area network. In other embodiments the invention may be implemented in access controllers not implemented in a WLAN and in network systems other than access controllers where the problem of tunnelling protocols or encryption prevent the network node from identifying the contents of a received message. An example of such is that of a digital subscriber line (xDSL) server such as a asymmetric digital subscriber line ADSL server.

1. An access controller for use in a communication network comprising:
a first address space for use by a user equipment in communication with an access controller via a first port;
a second address space for use via an external network in communication with the access controller via a second port;
a processor configured to read incoming requests at the first and second ports wherein requests of a predetermined type issued by the user equipment to be implemented at the access controller are received at the first port yet addressed to the second address space.

2. An access controller as claimed in claim 1, wherein said request of a predetermined type is a request to open a uniform resource location (URL) in the second address space.

3. An access controller as claimed in claim 1, wherein said request of a predetermined type is one of a status update and a disconnect request.

4. An access controller as claimed in claim 1, wherein said request of a predetermined type is encrypted, and wherein the processor is configured to transmit the request received at the first port to the external network via the second port, where it is decrypted, and to subsequently receive the decrypted request at the second port.

5. An access controller as claimed in claim 1, wherein the processor is configured to recognize that an incoming request at the first port is addressed to the second address space and to implement the request at the access controller.

6. An access controller as claimed in claim 1, wherein said requests comprise information identifying said user equipment.

7. An access controller as claimed in claim 6, wherein said information identifying said user equipment comprises a session id.

8. An access controller as claimed in claim 1, wherein said processor is configured to send a response to the user equipment after implementing the request at the access controller.

9. An access controller as claimed in claim 8, wherein said processor is configured to disconnect said user equipment when said request is a disconnect request.

10. An access controller as claimed in claim 8, wherein said response comprises status information.

11. An access controller as claimed in claim 1, wherein said external network comprises a virtual private network (VPN) gateway.

12. An access controller as claimed in claim 1, wherein said first port is a private communications port.

13. An access controller as claimed in claim 1, wherein said second port is a public communications port.

14. An access controller as claimed in claim 12, wherein said first address space is a private address space.

15. An access controller as claimed in claim 13, wherein said second address space is a public address space.

16. An access controller as claimed in claim 1, wherein said user equipment is in wireless communication with the access controller via the first port.

17. A communications system comprising:
at least one user equipment;
at least one external network; and
an access controller comprising
a first address space for use by said at least one user equipment in communication with the access controller via a first port,
a second address space for use via said at least one external network in communication with the access controller via a second port, and
a processor configured to read incoming requests at the first and second ports wherein requests of a predetermined type issued by the at least one user equipment to be implemented at the access controller are received at the first port yet addressed to the second address space.

18. A method of controlling access in a communications network including an access controller, a user equipment in communication with the access controller via a first port associated with a first address space and an external network in communication with the access controller by a second port associated with a second address space, comprising the steps of:
transmitting from a user equipment a request to be implemented at an access controller and identifying a location in a second address space; and
implementing the request at the access controller.

19. A method as claimed in claim 18, wherein said step of transmitting further comprises transmitting from the user equipment one of a status update and a disconnect request to be implemented at the access controller.

20. A method as claimed in claim 18, further comprising the step of issuing a response to the user equipment after implementing the request at the access controller.

21. A method as claimed in claim 18, wherein said request transmitted from the user equipment is encrypted, said method further comprising the steps of:
transmitting said request to an external network;
decrypting said request at said external network; and
returning said decrypted request to the access controller.

22. A method as claimed in claim 18, wherein the method further comprises reading said request at said access controller on its arrival at a first port.

23. A method as claimed in claim 18, wherein said location is a uniform resource location (URL).

24. A method as claimed in claim 18, wherein said request is transmitted from the user equipment to the access controller over a wireless link.

25. A user equipment comprising:
a first port arranged to establish a communications link to an external network via an access controller;
a processor configured to count encrypted data packets transmitted over the communications link and to generate a status report for the communications link using a result of the count, said status report being independent of a decryption of the encrypted data packets.

26. A user equipment as claimed in claim 25, wherein said processor is configured to execute a program for updating a status window at the user equipment.

27. A user equipment as claimed in claim 26, wherein said program is a javascript program.

28. A method of reporting status in a communications network comprising an access controller, and a user equipment in communication with the access controller via a communications link, comprising the steps of:
counting encrypted data packets transmitted over a communications link; and
generating a status report for the communications link using a result of the counting step, said status report being independent of a decryption of the encrypted data packets.

29. A method as claimed in claim 28, further comprising the step of updating a status window at a user equipment using said status report.

30. A method as claimed in claim 29, wherein said step of updating a status window comprises the step of running a javascript program.
